(19) United States
(12) Patent Application Publication
(10) Pub. No.: US 2007/0196245 A1
(43) Pub. Date: Aug. 23, 2007

(54) DIESEL PARTICULATE FILTER

(75) Inventors: Hiroki Fujita, Hiroshima (JP); Koichiro Harada, Hiroshima (JP); Kenji Okamoto, Hiroshima (JP); Yoshinori Tsushio, Hiroshima (JP); Akihide Takami, Hiroshima (JP); Kenji Suzuki, Hiroshima (JP)

Correspondence Address: BROOKS KUSHMAN P.C., 1000 TOWN CENTER, TWENTY-SECOND FLOOR, SOUTHFIELD, MI, 48075, US

(73) Assignee: MAZDA MOTOR CORPORATION, Hiroshima (JP)

(21) Appl. No.: 11/675,855

(22) Filed: Feb. 16, 2007

(30) Foreign Application Priority Data
Feb. 20, 2006 (JP) 2006-042212

(51) Int. Cl. B01J 23/00

(52) U.S. Cl. 422/177; 502/304

(57) ABSTRACT

Walls forming exhaust gas channels in a DPF are coated with a catalyst layer for promoting the burning of particulates trapped thereon. The catalyst layer contains alumna and a composite oxide containing Ce as a major component and rare earth metal other than Ce or alkali earth metal. Pt is loaded on the alumina and the composite oxide.

### CROSS-REFERENCE TO RELATED APPLICATION

This application claims priority under 35 USC 119 to Japanese Patent Application No. 2006-42212 filed with the JPO on Feb. 20, 2006, the entire contents of which are incorporated herein by reference.

### BACKGROUND OF THE INVENTION

(a) Field of the Invention

This invention relates to diesel particulate filters.

(b) Description of the Related Art

In order to prevent particulates (gas-borne particulate matter) contained in exhaust gas of a diesel engine from being emitted into the air, it is effective to fit a diesel particulate filter (DPF) in the exhaust pipe of the engine. The DPF is obtained by forming a heat-resistance ceramic material, such as silicon carbide (SiC) or cordierite, in a three-dimensional network structure or a wall-through honeycomb structure. Particulates in exhaust gas are trapped by the DPF during the passage of the exhaust gas through the DPF. In order to burn off trapped particulates, the DPF has a catalyst layer coated on the wall surfaces of exhaust gas channels in the DPF. For example, Published Japanese Patent Application No. 2003-334443 discloses that a mixture of cerium-zirconium (Ce—Zr) composite oxide and γ-alumina is loaded on a monolith support and platinum (Pt) is loaded on the mixture at 2 g per 1 L of the monolith support.

Though the above document also discloses that Ce—Zr composite oxide is effective in increasing the particulate burning rate under low-temperature conditions, there is a demand in the art to further increase the particulate burning rate to burn off particulates more efficiently.

Specifically, in order to burn off particulates deposited on the DPF, there has been a need, for example, to dispose an oxidation catalyst upstream of the DPF, supply fuel to the oxidation catalyst, and use reaction heat produced therein to increase the DPF temperature. To satisfy the need, the amount of fuel supplied to the engine is increased relative to that in normal operation so that unburned fuel in the engine can be supplied to the oxidation catalyst. Therefore, in order to avoid deterioration in fuel efficiency due to regeneration of the DPF, it is desired to further increase the particulate burning rate.

Meanwhile, it is preferable that unburned components in exhaust gas, such as hydrocarbons (HC) and carbon monoxide (CO), are converted by a catalyst disposed upstream of the DPF. In order to enhance the conversion efficiency, it is desired to efficiently convert such unburned components also in the DPF. Since, particularly in regenerating the DPF, the amount of fuel supplied to the engine is increased, it is desired to enhance the exhaust gas purification performance of the DPF.

The particulate burning rate and the exhaust gas purification performance of the DPF can be enhanced by increasing the amount of catalytic metal loaded on the support material, such as a composite oxide as described above. However, if the amount of catalytic metal loaded on the support material is increased, the DPF becomes more expensive correspondingly.

### SUMMARY OF THE INVENTION

Bearing in mind the above, an object of the present invention is to enhance the particulate burning rate and the exhaust gas purification performance of the DPF while minimizing the amount of catalytic metal used.

The inventor has found that a composite oxide containing Ce as a major component and rare earth metal other than Ce or alkali earth metal is effective in increasing the particulate burning rate and combining the composite oxide with alumina and Pt enhances the exhaust gas purification performance of the DPF concurrently, thereby completing the present invention.

More specifically, the present invention is directed to a diesel particulate filter, disposed in an exhaust passage of a diesel engine, for trapping particulates exhausted from the engine, wherein walls forming exhaust gas channels in a filter body on which the particulates are trapped are coated with a catalyst layer for promoting the burning of the trapped particulates, the catalyst layer contains alumna and a composite oxide containing Ce as a major component and rare earth metal other than Ce or alkali earth metal, and Pt is loaded on the alumina and the composite oxide.

According to the present invention, the particulate burning rate of the DPF increases and the exhaust gas purification performance thereof enhances.

The reason why the particulate burning rate increases can be considered as follows. When particulates trapped by the DPF reacts with oxygen released from the composite oxide to generate firing points, the areas around the firing points run short of oxygen. However, since the composite oxide has a higher oxygen ionic conductivity than Ce—Zr composite oxide conventionally used, oxygen ions are likely to be efficiently and continuously supplied from high oxygen concentration sites via the composite oxide to the firing points. Therefore, it can be considered that once firing points are generated, particulates rapidly burn off even if the amount of Pt loaded as a catalyst is small.

On the other hand, since the catalyst layer contains a catalytic component obtained by loading Pt on alumina, the catalytic component efficiently converts HC and CO in exhaust gas by oxidation. Furthermore, as later shown by experimental data, the catalytic component acts to increase the particulate burning rate, combined with the Pt-loading composite oxide.

The ratio of the amount of Pt loaded on the alumina to the total amount of Pt loaded on the composite oxide and Pt loaded on the alumina is preferably not less than 35 mass %.

As described above, the catalytic component obtained by loading Pt on alumina is effective in enhancing the exhaust gas purification performance of the DPF. However, if the ratio of the amount of Pt loaded on the alumina is low, as later shown in experimental data, the effect is not sufficiently exhibited and the exhaust gas purification performance is rather deteriorated. Therefore, the ratio of the amount of Pt loaded on the alumina is preferably not less than 35 mass %, which surely enhances the exhaust gas purification performance of the DPF.

The ratio of the amount of Pt loaded on the alumina is preferably not more than 90 mass %. Increasing the ratio of the amount of Pt loaded on the alumina is effective in enhancing the exhaust gas purification performance of the DPF. However, if the ratio is excessive, the amount of Pt to be loaded on the composite oxide becomes smaller correspondingly. Since the Pt-loading composite oxide greatly contributes to increasing the particulate burning rate, the ratio of the amount of Pt loaded on the alumina is preferably not more than 90 mass % in order to avoid decrease in the particulate burning rate.

The ratio of the amount of Pt loaded on the alumina is more preferably between 50 mass % and 90 mass % both inclusive and still more preferably more than 50 mass %.

Preferably, palladium (Pd) is further loaded on the alumina on which Pt is loaded. This enhances the exhaust gas purification performance of the DPF under low-temperature conditions. In this case, though Pd is inferior in heat resistance to Pt, this is not significant disadvantage. The reason for this is, as described above, that the combination of the Pt-loading composite oxide and the Pt-loading alumina increases the particulate burning rate and, therefore, particulates can be well burnt off without the need to increase the DPF temperature as conventionally done. In other words, since there is no need to increase the DPF temperature to a high temperature as conventionally done in order to burn off particulates, this avoids thermal deterioration of Pd. Therefore, Pd can be effectively used to enhance the exhaust gas purification performance under low-temperature conditions.

The rare earth metal preferably comprises at least one selected from Sm and Gd, and the alkali earth metal preferably comprises at least one selected from Mg, Ca, Sr and Ba.

As can be seen from the above, according to the present invention, even if the amount of Pt loaded is not so much, the particulate burning rate of the DPF increases and the exhaust gas purification performance thereof enhances. This is advantageous in rapid regeneration and exhaust gas conversion of the DPF at relatively low temperatures, improves fuel efficiency and provides cost reduction of the DPF.

### BRIEF DESCRIPTION OF THE DRAWINGS

FIG. 1 is an exhaust gas purification system for a diesel engine.

FIG. 2 is a front view schematically showing a DPF.

FIG. 3 is a vertically cross-sectional view schematically showing the DPF.

FIG. 4 is an enlarged cross-sectional view schematically showing a wall that separates an exhaust gas inflow channel from an exhaust gas outflow channel in the DPF.

FIG. 5 is a conceptual diagram illustrating an example of the structure of components contained in a catalyst layer in the DPF.

FIG. 6 is a graph showing carbon burning rates of various oxides on which Pt is loaded.

FIG. 7 is a graph showing the exhaust gas purification performance of the DPF according to an embodiment of the present invention using a Ce—Sm composite oxide.

FIG. 8 is a graph showing the carbon burning rate of the DPF according to the above embodiment.

### DETAILED DESCRIPTION OF THE INVENTION

A preferred embodiment of the present invention will be described below with reference to the drawings.

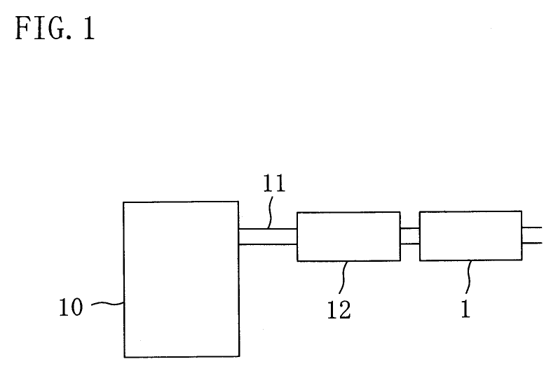

In FIG. 1, the reference numeral 1 denotes a DPF disposed in an exhaust passage 11 of a diesel engine 10. An upstream catalyst 12 is disposed in the exhaust passage 11 upstream of the DPF 1 in the flow direction of exhaust gas. A NOx trap catalyst having oxidation catalytic function, an oxidation catalyst containing no NOx storage component or both can be disposed as the upstream catalyst 12.

The NOx trap catalyst is obtained by loading, on a support material such as active alumina, a NOx storage component (such as an alkali earth metal, typically Ba, or an alkali metal) for absorbing NOx in the exhaust gas at high oxygen concentrations in the exhaust gas (at lean air-fuel ratios) and a catalytic metal, such as Pt, for reducing NOx released from the NOx storage component when the oxygen concentration in the exhaust gas drops (at stoichiometric or rich air-fuel ratios), and also acts as a catalyst for converting HC and CO to harmless substances by oxidation.

The oxidation catalyst is obtained by loading a catalytic metal, such as Pt or Pd, on a support material such as active alumina and acts to oxidize HC and CO in the exhaust gas. When the oxidation catalyst is disposed upstream of the DPF 1, NO in the exhaust gas is oxidized into NO₂ by the oxidation catalyst and produced NO₂ is then supplied as an oxidizing agent for burning particulates to the DPF 1.

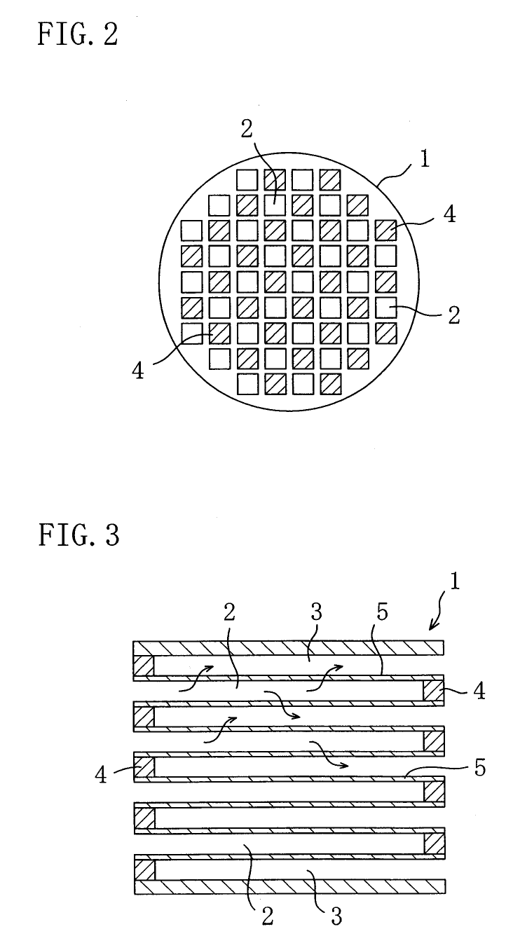

As schematically shown in FIGS. 2 and 3, the DPF 1 has a honeycomb structure in which a large number of exhaust gas channels 2 and 3 run in parallel with each other. Specifically, the DPF 1 has a structure in which a plurality of exhaust gas inflow channels 2 and a plurality of exhaust gas outflow channels 3 are alternately arranged vertically and horizontally. Each exhaust gas inflow channel 2 is closed at the downstream end by a plug 4, while each exhaust gas outflow channel 3 is closed at the upstream end by a plug 4. The adjacent exhaust gas inflow and outflow channels 2 and 3 are separated from each other by a thin partition wall 5. In FIG. 2, the hatched parts denote the plugs 4 at the upstream ends of the exhaust gas outflow channels 3.

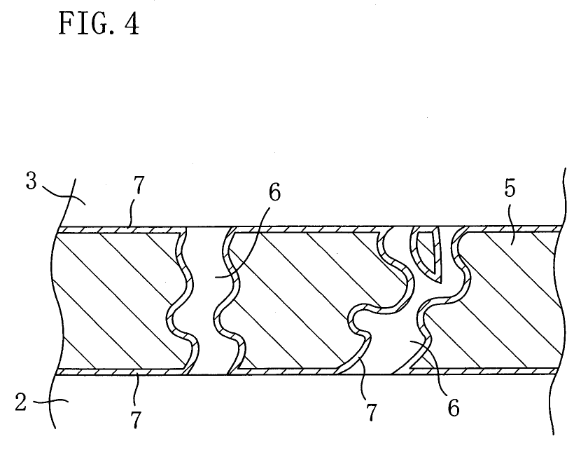

The body of the DPF 1 is formed of cordierite or an inorganic porous material, such as SiC, Si₃N₄ or sialon. The exhaust gas flowing into each exhaust gas inflow channel 2 flows out through the surrounding partition walls 5 into the adjacent exhaust gas outflow channels 3, as shown in arrows in FIG. 3. More specifically, as shown in FIG. 4, each partition wall 5 is formed with micro pores (exhaust gas channels) 6 communicating the exhaust gas inflow channel 2 with the adjacent exhaust gas outflow channel 3 so that the exhaust gas flows through the micro pores 6. Particulates are trapped and deposited mainly on the wall surfaces of the exhaust gas inflow channels 2 and the micro pores 6.

A catalyst layer 7 for promoting the burning of trapped particulates is coated on the walls of all the exhaust gas channels (i.e., exhaust gas inflow channels 2, exhaust gas outflow channels 3 and micro pores 6) in the body of the DPF 1. The catalyst layer 7 contains alumina and a composite oxide containing Ce as a major component and rare earth metal other than Ce or alkali earth metal and at least Pt is loaded as a catalytic metal on the alumina and the composite oxide. However, it is not necessarily required to form the catalyst layer on the walls of the exhaust gas outflow channels 3.

A detailed description will be given below of the catalyst layer of the DPF 1.

### <General Structure of Catalyst Layer>

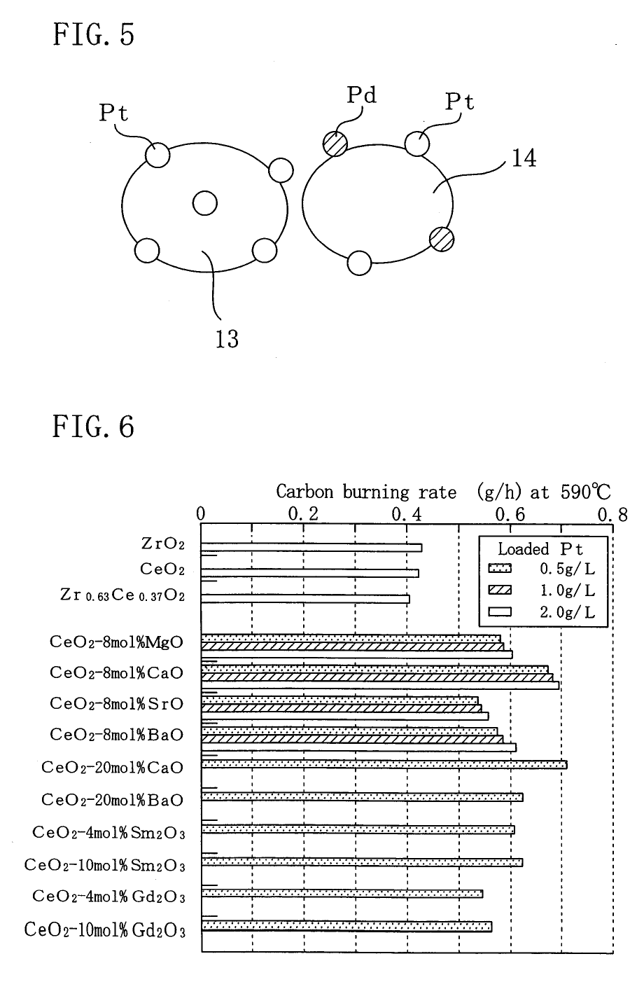

FIG. 5 is a conceptual diagram showing the structure of components constituting the catalyst layer in the DPF 1 according to the present invention. In FIG. 5, the reference numeral 13 denotes a composite oxide particle contained in the catalyst layer and loading Pt particles, and the reference numeral 14 denotes an alumina particle contained in the catalyst layer and loading Pt particles and Pd particles. Some alumina particles 14 in the catalyst layer loads no Pd particles. The composite oxide particle 13 may load one or more other kinds of catalytic metal particles in addition to Pt particles and the alumina particle 14 may load one or more other kinds of catalytic metal particles in addition to Pt and Pd particles.

### <Carbon Burning Rates of Various Kinds of Oxides>

FIG. 6 shows results of measurement of carbon burning rates carried out in order to evaluate the diesel particulate burning rates of various kinds of oxides including composite oxides, in which the carbon burning rates of the oxides were measured instead of the diesel particulate burning rates. Samples for the evaluation were prepared as follows. First, a slurry was prepared by adding a ZrO₂ binder and ion-exchange water to each oxide on which Pt particles were loaded. The obtained slurry was coated on the wall surfaces of the exhaust gas channels in a SiC filter body of 25 mL capacity uniformly over the entire filter length. Then, the filter was calcined by keeping it at 500° C. for two hours under atmospheric conditions. In loading Pt on each oxide, a solution of diamminedinitro platinum nitrate was used as a Pt source and an evaporation-to-dryness method was employed.

Before the measurement of the carbon burning rate, each sample was aged by keeping it at 800° C. for 24 hours under atmospheric conditions and 10 g/L of carbon was then deposited on the catalyst layer of the sample. Next, each sample was attached to a fixed-bed flow reactor and the internal temperature of the reactor was raised from room temperature at a rate of 15° C. per minute with the sample in a flow of nitrogen gas containing 10 volume % of oxygen. Then, when the gas temperature reached 590° C., the carbon burning rate of the sample was determined by examining changes in CO concentration and CO₂ concentration in the gas having passed through the sample.

The left column of FIG. 6 indicates the kinds of oxides used. In this column, Zr_{0.63}Ce_{0.37}O₂ is a Zr—Ce composite oxide containing Zr and Ce at a molar ratio of 63:37. Oxides including CeO₂-8 mol % MgO and listed below it are binary oxides containing Ce as a major component and one kind of alkali earth metal or rare earth metal, such as Mg, but not containing Zr. The term “mol %” means that, for example, in CeO₂-8 mol % MgO, the composite oxide contains 8% by mole of MgO with respect to its total molar quantity. All of these composite oxides were prepared by coprecipitation. The term “loaded Pt” described in the upper right corner of FIG. 6 means the value showing the amount of Pt loaded per 1 L of filter body.

FIG. 6 shows that the Zr—Ce composite oxide has a smaller carbon burning rate than ZrO₂ and CeO₂, that the binary oxides containing Ce as a major component and one kind of alkali earth metal or rare earth metal have much higher carbon burning rates than not only the Zr—Ce composite oxide but also ZrO₂ and CeO₂, and particularly that though the amount of Pt loaded of each of the Zr—Ce composite oxide, ZrO₂ and CeO₂ was 2 g/L, the composite oxides containing Ce as a major component have much higher carbon burning rates than the Zr—Ce composite oxide, ZrO₂ and CeO₂ even if they have a smaller amount of Pt loaded of 0.5 g/L. It can be seen from this that the composite oxides used in the DPF according to the present invention are very useful in rapidly burning off particulates.

### EMBODIMENT 1

The DPF of this embodiment employs as a composite oxide a binary oxide containing Ce and Sm but containing no Zr. The Ce—Sm composite oxide (CeSmO) contains 4 mol % of Sm₂O₃ with respect to its total molar quantity and was prepared by coprecipitation. The method of producing the DPF is as follows.

Powder of a Pt-loading CeSmO (Pt/CeSmO) obtained by loading Pt particles on a Ce—Sm composite oxide was mixed with powder of a Pt-loading Al₂O₃ (Pt/Al₂O₃) obtained by loading Pt particles on γ-alumina and a ZrO₂ binder and ion-exchange water were added to the powder mixture to obtain a slurry. The obtained slurry was coated on the wall surfaces of exhaust gas channels in a SiC filter body of 25 mL capacity uniformly over the entire filter length and the filter was calcined by keeping it at 500° C. for two hours under atmospheric conditions. In loading Pt on the Ce—Sm composite oxide and γ-alumina, an evaporation-to-dryness method was employed.

Then, a plurality of DPF samples were prepared that have different ratios of the amount of Pt loaded on γ-alumina to the total amount of Pt loaded on the Ce—Sm composite oxide and γ-alumina (hereinafter, referred to as the alumina-side Pt loading ratio) and each sample was measured in terms of exhaust gas purification performance and particulate burning rate. These samples are of five types having a common amount of Pt/CeSmO powder loaded of 25 g/L (wherein g/L means gram per 1 L of filter body; the same applies hereinafter), a common amount of Pt/Al₂O₃ powder loaded of 25 g/L, a common total amount of Pt in Pt/CeSmO and Pt/Al₂O₃ (i.e., amount of Pt loaded on CeSmO and Al₂O₃) of 0.5 g/L and different alumina-side Pt loading ratios of 0 mass %, 25 mass %, 50 mass %, 75 mass % and 100 mass %. For example, in the sample having an alumina-side Pt loading ratio of 75 mass %, the amount of Pt in Pt/CeSmO is 0.125 g/L and the amount of Pt in Pt/Al₂O₃ is 0.375 g/L.

### Evaluation Test for Exhaust Gas Purification Performance

Each sample was aged by keeping it at 800° C. for 24 hours under atmospheric conditions as described above and then subjected to a rig test to measure its T50 (° C.) and C300 (%) that are indices for HC and CO conversion performance. The rig test was carried out by attaching each sample to a fixed bed flow reactor. The synthesized exhaust gas used had an A/F ratio of 28 and the following composition:

O₂: 10 volume %, water vapor (H₂O): 10 volume %, CO₂: 4.5 volume %, HC:200 ppmC (converted to carbon amount), CO: 300 ppm, NO: 500 ppm and N₂: the rest

T50 (° C.) is the gas temperature at the inlet of the DPF when the concentration of each exhaust gas component (HC and CO) detected downstream of the DPF reaches half of that of the corresponding exhaust gas component flowing into the DPF (when the conversion efficiency reaches 50%) after the temperature of the synthesized exhaust gas is gradually increased (i.e., the light-off temperature), and indicates the low-temperature catalytic conversion performance of the DPF.

C300 (%) is the catalytic conversion efficiency of each exhaust gas component (HC and CO) when the synthesized exhaust gas temperature at the DPF inlet is 300° C. and indicates the high-temperature catalytic conversion performance of the DPF.

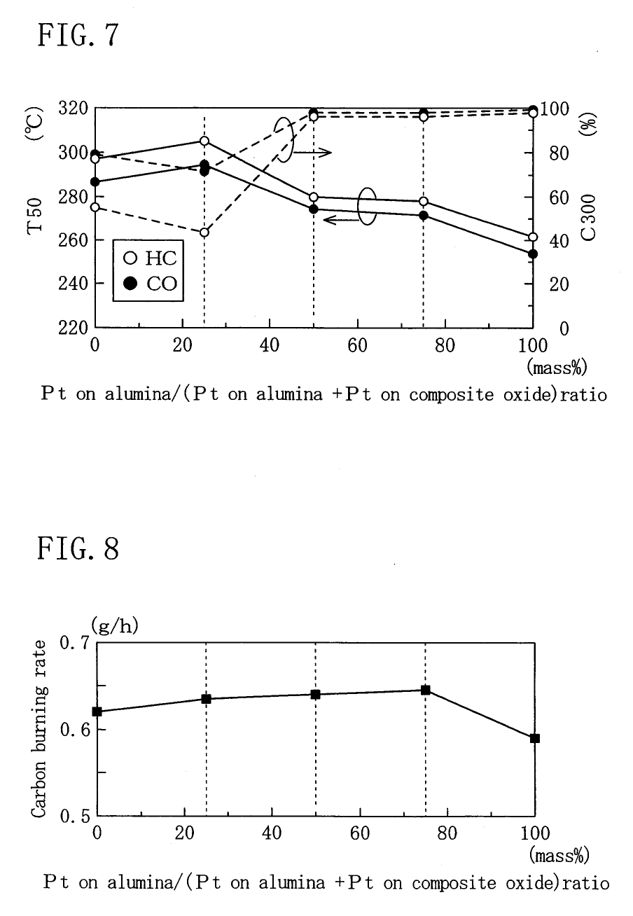

The test results for T50 (° C.) and the test results for C300 (%) are shown in FIG. 7. Referring to T50, when the alumina-side Pt loading ratio increased from 0 to 25 mass %, both HC and CO exhibited slightly higher T50. As the alumina-side Pt loading ratio further increased, HC and CO gradually decreased T50. Referring to C300, when the alumina-side Pt loading ratio increased from 0 to 25 mass %, both HC and CO slightly decreased. As the alumina-side Pt loading ratio further increased, HC and CO gradually increased C300. When the alumina-side Pt loading ratio was about 30 to about 35 mass %, HC and CO exhibited substantially the same T50 and C300 performances as those when the alumina-side Pt loading ratio was 0 mass %. Therefore, it can be seen that the alumina-side Pt loading ratio is preferably not less than 35 mass %, and more preferably not less than 50 mass %.

### Evaluation Test for Particulate Burning Rate

The carbon burning rate of each sample was determined, in the same manner as in the carbon burning rate measurement as described above with reference to FIG. 6, in a flow of nitrogen gas containing 10 volume % of oxygen and 300 ppm of NO when the gas temperature reached 590° C. The results are as shown in FIG. 8.

FIG. 8 shows that as the alumina-side Pt loading ratio increased to 75 mass %, the carbon burning rate steadily increased but that when the alumina-side Pt loading ratio reached 100 mass %, the carbon burning rate became smaller than when it was 0 mass %. Therefore, it can be seen from the figure that in order to provide high particulate burning rates, the alumina-side Pt loading ratio is preferably not more than 90 mass %.

### Effects of Pd Loading on Exhaust Gas Purification Performance

With the use of the sample having an alumina-side Pt loading ratio of 75 mass % and in the same manner as described above, a Pt additionally loading sample was prepared by additionally loading 0.5 g/L of Pt on γ-alumina loading 0.375 g/L of Pt and a Pd additionally loading sample was prepared by additionally loading 0.3 g/L of Pd on γ-alumina loading 0.375 g/L of Pt. Then, each of the obtained samples was subjected to an evaluation test for exhaust gas purification performance in the same manner as described above. The total amount of catalytic metal loaded of the Pt additionally loading sample was 1.0 g/L and the total amount of catalytic metal loaded of the Pd additionally loading sample was 0.8 g/L. The test results are shown in Table 1.

TABLE 1

| | T50 (° C.) | |
|---|---|---|
| | HC | CO |
| Pt (0.125)/CeSmO:Pt (0.375)/Al₂O₃ = 1:1 (mass ratio) | 278 | 272 |
| Pt (0.125)/CeSmO:Pt (0.875)/Al₂O₃ = 1:1 (mass ratio) | 254 | 247 |
| Pt (0.125)/CeSmO:Pt (0.375) + Pd (0.3)/Al₂O₃ = 1:1 | 243 | 230 |
| (mass ratio) | | |

CeSmO is a Ce—Sm composite oxide containing 4 mol % of Sm₂O₃.

Table 1 shows that when Pt was additionally loaded on γ-alumina, both HC and CO exhibited better T50 performance and also shows that when Pd was additionally loaded on γ-alumina, both HC and CO exhibited still better T50 performance. Furthermore, while the amount of Pt additionally loaded is 0.5 g/L, the amount of Pd additionally loaded is 0.3 g/L that is smaller than the former. Therefore, additionally loading Pd on γ-alumina significantly improves the exhaust gas purification performance of the DPF.

### EMBODIMENT 2

The DPF of this embodiment employs, instead of the Ce—Sm composite oxide in Embodiment 1, a Ce—Gd composite oxide (CeGdO) containing 4 mol % of Gd₂O₃ and the other points are the same as in Embodiment 1. In the same manner as in Embodiment 1, five DPF samples were prepared that have different alumina-side Pt loading ratios of 0 mass %, 25 mass %, 50 mass %, 75 mass % and 100 mass %. Furthermore, with the use of the sample having an alumina-side Pt loading ratio of 75 mass % and in the same manner as described above, a Pt additionally loading sample was prepared by additionally loading 0.5 g/L of Pt on γ-alumina and a Pd additionally loading sample was prepared by additionally loading 0.3 g/L of Pd on γ-alumina. Then, as in Embodiment 1, the above five samples were subjected to evaluation tests for exhaust gas purification performance and particulate burning rate and the Pt additionally loading sample and the Pd additionally loading sample were subjected to an evaluation test for exhaust gas purification performance. The test results are shown in Tables 2 and 3.

TABLE 2

| PDF using | | | | | Carbon |
|---|---|---|---|---|---|
| Ce—Gd composite oxide | | | | | burning |
| Pt on Al₂O₃/ | T50 (° C.) | | C300 (%) | | rate |
| (Pt on Al₂O₃ + Pt on CeGdO) | HC | CO | HC | CO | (g/h) |
| 0 mass % | 295 | 285 | 65.9 | 86.6 | 0.6 |
| 25 mass % | 292 | 280 | 66 | 87 | 0.62 |
| 50 mass % | 287 | 277 | 82 | 95 | 0.63 |
| 75 mass % | 280 | 270 | 94 | 98 | 0.64 |
| 100 mass % | 268 | 258 | 97 | 98.5 | 0.58 |

CeGdO is a Ce—Gd composite oxide containing 4 mol % of Gd₂O₃.

TABLE 3

| | T50 (° C.) | |
|---|---|---|
| | HC | CO |
| Pt (0.125)/CeGdO:Pt (0.375)/Al₂O₃ = 1:1 (mass ratio) | 280 | 270 |
| Pt (0.125)/CeGdO:Pt (0.875)/Al₂O₃ = 1:1 (mass ratio) | 258 | 251 |
| Pt (0.125)/CeGdO:Pt (0.375) + Pd (0.3)/Al₂O₃ = 1:1 | 243 | 231 |
| (mass ratio) | | |

CeGdO is a Ce—Gd composite oxide containing 4 mol % of Gd₂O₃.

Table 2 shows that also when the Ce—Gd composite oxide was used as a composite oxide, as in the case of using the Ce—Sm composite oxide in Embodiment 1, high exhaust gas purification performance was obtained and the particulate burning rate increased. Furthermore, as in Embodiment 1, the carbon burning rate gradually increased as the alumina-side Pt loading ratio increased, but it decreased when the alumina-side Pt loading ratio was excessive. On the other hand, the case of using the Ce—Gd composite oxide is slightly different from the case of using the Ce—Sm composite oxide in Embodiment 1 in that it did not deteriorate the exhaust gas purification performance at an alumina-side Pt loading ratio of 25 mass % and the exhaust gas purification performance gradually increased as the alumina-side Pt loading ratio increased. However, no significant difference exists between the carbon burning rate at an alumina-side Pt loading ratio of 0 mass % and the carbon burning rate at an alumina-side Pt loading ratio of 25 mass %. Therefore, also in the case of using the Ce—Gd composite oxide, the alumina-side Pt loading ratio is preferably not less than 35 mass %.

Table 3 shows that also in the case of using the Ce—Gd composite oxide, as in the case of using the Ce—Sm composite oxide in Embodiment 1, the Pd additionally loading DPF sample exhibited better T50 performance for HC and CO than the Pt additionally loading DPF sample.

### EMBODIMENT 3

The DPF of this embodiment employs, instead of the Ce—Sm composite oxide in Embodiment 1, a Ce—Mg composite oxide (CeMgO) containing 8 mol % of MgO and the other points are the same as in Embodiment 1. In the same manner as in Embodiment 1, five DPF samples were prepared that have different alumina-side Pt loading ratios of 0 mass %, 25 mass %, 50 mass %, 75 mass % and 100 mass %. Furthermore, with the use of the sample having an alumina-side Pt loading ratio of 75 mass % and in the same manner as described above, a Pt additionally loading sample was prepared by additionally loading 0.5 g/L of Pt on γ-alumina and a Pd additionally loading sample was prepared by additionally loading 0.3 g/L of Pd on γ-alumina. Then, as in Embodiment 1, the above five samples were subjected to evaluation tests for exhaust gas purification performance and particulate burning rate and the Pt additionally loading sample and the Pd additionally loading sample were subjected to an evaluation test for exhaust gas purification performance. The test results are shown in Tables 4 and 5.

TABLE 4

| PDF using Ce—Mg | | | | | Carbon |
|---|---|---|---|---|---|
| composite oxide | | | | | burning |
| Pt on Al₂O₃/(Pt on | T50 (° C.) | | C300 (%) | | rate |
| Al₂O₃ + Pt on CeMgO) | HC | CO | HC | CO | (g/h) |
| 0 mass % | 310 | 302 | 23.3 | 45.8 | 0.61 |
| 25 mass % | 295 | 287 | 58 | 77 | 0.64 |
| 50 mass % | 292 | 280 | 65 | 86 | 0.65 |
| 75 mass % | 285 | 273 | 80 | 94 | 0.63 |
| 100 mass % | 275 | 263 | 93 | 97 | 0.58 |

CeMgO is a Ce—Mg composite oxide containing 8 mol % of MgO.

TABLE 5

| | T50 (° C.) | |
|---|---|---|
| | HC | CO |
| Pt (0.125)/CeMgO:Pt (0.375)/Al₂O₃ = 1:1 (mass ratio) | 285 | 273 |
| Pt (0.125)/CeMgO:Pt (0.875)/Al₂O₃ = 1:1 (mass ratio) | 262 | 255 |
| Pt (0.125)/CeMgO:Pt (0.375) + Pd (0.3)/Al₂O₃ = 1:1 | 253 | 241 |
| (mass ratio) | | |

CeMgO is a Ce—Mg composite oxide containing 8 mol % of MgO.

Table 4 shows that also when the Ce—Mg composite oxide was used as a composite oxide, high exhaust gas purification performance was obtained and the particulate burning rate increased. Furthermore, as in Embodiment 2, the exhaust gas purification performance and the carbon burning rate gradually enhanced as the alumina-side Pt loading ratio increased, but the carbon burning rate decreased when the alumina-side Pt loading ratio was excessive. In this case, when the alumina-side Pt loading ratio increased from 0 mass % to 25 mass %, both the exhaust gas purification performance and the carbon burning rate significantly enhanced. Therefore, the alumina-side Pt loading ratio is preferably not less than 25 mass %.

Table 5 shows that also in the case of using the Ce—Mg composite oxide, as in the case of using the Ce—Sm composite oxide in Embodiment 1, the Pd additionally loading DPF sample exhibited better T50 performance for HC and CO than the Pt additionally loading DPF sample.

### EMBODIMENT 4

The DPF of this embodiment employs, instead of the Ce—Sm composite oxide in Embodiment 1, a Ce—Ca composite oxide (CeCaO) containing 8 mol % of CaO and the other points are the same as in Embodiment 1. In the same manner as in Embodiment 1, five DPF samples were prepared that have different alumina-side Pt loading ratios of 0 mass %, 25 mass %, 50 mass %, 75 mass % and 100 mass %. Furthermore, with the use of the sample having an alumina-side Pt loading ratio of 75 mass % and in the same manner as described above, a Pt additionally loading sample was prepared by additionally loading 0.5 g/L of Pt on γ-alumina and a Pd additionally loading sample was prepared by additionally loading 0.3 g/L of Pd on γ-alumina. Then, as in Embodiment 1, the above five samples were subjected to evaluation tests for exhaust gas purification performance and particulate burning rate and the Pt additionally loading sample and the Pd additionally loading sample were subjected to an evaluation test for exhaust gas purification performance. The test results are shown in Tables 6 and 7.

TABLE 6

| PDF using Ce—Ca | | | | | Carbon |
|---|---|---|---|---|---|
| composite oxide | | | | | burning |
| Pt on Al₂O₃/(Pt on | T50 (° C.) | | C300 (%) | | rate |
| Al₂O₃ + Pt on CeCaO) | HC | CO | HC | CO | (g/h) |
| 0 mass % | 303 | 297 | 37.6 | 60.8 | 0.87 |
| 25 mass % | 293 | 282 | 62 | 88 | 0.9 |
| 50 mass % | 285 | 275 | 85 | 92 | 0.91 |
| 75 mass % | 281 | 272 | 96 | 98 | 0.91 |
| 100 mass % | 269 | 260 | 98 | 99 | 0.79 |

CeCaO is a Ce—Ca composite oxide containing 8 mol % of CaO.

TABLE 7

| | T50 (° C.) | |
|---|---|---|
| | HC | CO |
| Pt (0.125)/CeCaO:Pt (0.375)/Al₂O₃ = 1:1 (mass ratio) | 281 | 272 |
| Pt (0.125)/CeCaO:Pt (0.875)/Al₂O₃ = 1:1 (mass ratio) | 259 | 251 |
| Pt (0.125)/CeCaO:Pt (0.375) + Pd (0.3)/Al₂O₃ = 1:1 | 250 | 239 |
| (mass ratio) | | |

CeCaO is a Ce—Ca composite oxide containing 8 mol % of CaO.

Table 6 shows that also when the Ce—Ca composite oxide was used as a composite oxide, high exhaust gas purification performance was obtained and the particulate burning rate increased. Furthermore, as in Embodiment 2, the exhaust gas purification performance and the carbon burning rate gradually enhanced as the alumina-side Pt loading ratio increased, but the carbon burning rate decreased when the alumina-side Pt loading ratio was excessive. This case is characterized in that higher carbon burning rates were exhibited than in the former cases. Also in this case, when the alumina-side Pt loading ratio increased from 0 mass % to 25 mass %, both the exhaust gas purification performance and the carbon burning rate significantly enhanced. Therefore, the alumina-side Pt loading ratio is preferably not less than 25 mass %.

Table 7 shows that also in the case of using the Ce—Ca composite oxide, as in the case of using the Ce—Sm composite oxide in Embodiment 1, the Pd additionally loading DPF sample exhibited better T50 performance for HC and CO than the Pt additionally loading DPF sample.

### EMBODIMENT 5

The DPF of this embodiment employs, instead of the Ce—Sm composite oxide in Embodiment 1, a Ce—Sr composite oxide (CeSrO) containing 8 mol % of SrO and the other points are the same as in Embodiment 1. In the same manner as in Embodiment 1, five DPF samples were prepared that have different alumina-side Pt loading ratios of 0 mass %, 25 mass %, 50 mass %, 75 mass % and 100 mass %. Furthermore, with the use of the sample having an alumina-side Pt loading ratio of 75 mass % and in the same manner as described above, a Pt additionally loading sample was prepared by additionally loading 0.5 g/L of Pt on γ-alumina and a Pd additionally loading sample was prepared by additionally loading 0.3 g/L of Pd on γ-alumina. Then, as in Embodiment 1, the above five samples were subjected to evaluation tests for exhaust gas purification performance and particulate burning rate and the Pt additionally loading sample and the Pd additionally loading sample were subjected to an evaluation test for exhaust gas purification performance. The test results are shown in Tables 8 and 9.

TABLE 8

| PDF using Ce—Sr | | | | | Carbon |
|---|---|---|---|---|---|
| composite oxide | | | | | burning |
| Pt on Al₂O₃/(Pt on | T50 (° C.) | | C300 (%) | | rate |
| Al₂O₃ + Pt on CeSrO) | HC | CO | HC | CO | (g/h) |
| 0 mass % | 296 | 289 | 65.3 | 82.2 | 0.58 |
| 25 mass % | 290 | 278 | 80 | 88 | 0.61 |
| 50 mass % | 281 | 274 | 95 | 97 | 0.62 |
| 75 mass % | 272 | 271 | 96 | 98 | 0.63 |
| 100 mass % | 263 | 255 | 98 | 99 | 0.52 |

CeSrO is a Ce—Sr composite oxide containing 8 mol % of SrO.

TABLE 9

| | T50 (° C.) | |
|---|---|---|
| | HC | CO |
| Pt (0.125)/CeSrO:Pt (0.375)/Al₂O₃ = 1:.1 (mass ratio) | 272 | 271 |
| Pt (0.125)/CeSrO:Pt (0.875)/Al₂O₃ = 1:.1 (mass ratio) | 253 | 248 |
| Pt (0.125)/CeSrO:Pt (0.375) + Pd (0.3)/Al₂O₃ = 1:1 | 245 | 230 |
| (mass ratio) | | |

CeSrO is a Ce—Sr composite oxide containing 8 mol % of SrO.

Table 8 shows that also when the Ce—Sr composite oxide was used as a composite oxide, high exhaust gas purification performance was obtained and the particulate burning rate increased. Furthermore, as in Embodiment 2, the exhaust gas purification performance and the carbon burning rate gradually enhanced as the alumina-side Pt loading ratio increased, but the carbon burning rate decreased when the alumina-side Pt loading ratio was excessive. Also in this case, when the alumina-side Pt loading ratio increased from 0 mass % to 25 mass %, both the exhaust gas purification performance and the carbon burning rate significantly enhanced. Therefore, the alumina-side Pt loading ratio is preferably not less than 25 mass %.

Table 9 shows that also in the case of using the Ce—Sr composite oxide, as in the case of using the Ce—Sm composite oxide in Embodiment 1, the Pd additionally loading DPF sample exhibited better T50 performance for HC and CO than the Pt additionally loading DPF sample.

### EMBODIMENT 6

The DPF of this embodiment employs, instead of the Ce—Sm composite oxide in Embodiment 1, a Ce—Ba composite oxide (CeBaO) containing 8 mol % of BaO and the other points are the same as in Embodiment 1. In the same manner as in Embodiment 1, five DPF samples were prepared that have different alumina-side Pt loading ratios of 0 mass %, 25 mass %, 50 mass %, 75 mass % and 100 mass %. Furthermore, with the use of the sample having an alumina-side Pt loading ratio of 75 mass % and in the same manner as described above, a Pt additionally loading sample was prepared by additionally loading 0.5 g/L of Pt on γ-alumina and a Pd additionally loading sample was prepared by additionally loading 0.3 g/L of Pd on γ-alumina. Then, as in Embodiment 1, the above five samples were subjected to evaluation tests for exhaust gas purification performance and particulate burning rate and the Pt additionally loading sample and the Pd additionally loading sample were subjected to an evaluation test for exhaust gas purification performance. The test results are shown in Tables 10 and 11.

TABLE 10

| PDF using Ce—Ba | | | | | Carbon |
|---|---|---|---|---|---|
| composite oxide | | | | | burning |
| Pt on Al₂O₃/(Pt on | T50 (° C.) | | C300 (%) | | rate |
| Al₂O₃ + Pt on CeBaO) | HC | CO | HC | CO | (g/h) |
| 0 mass % | 317 | 311 | 11.1 | 22.7 | 0.785 |
| 25 mass % | 307 | 296 | 44.4 | 71.9 | 0.88 |
| 50 mass % | 297 | 287 | 59.0 | 78.0 | 0.8 |
| 75 mass % | 287 | 278 | 85.0 | 94.0 | 0.79 |
| 100 mass % | 269 | 262 | 96.0 | 98.0 | 0.65 |

CeBaO is a Ce—Ba composite oxide containing 8 mol % of BaO.

TABLE 11

| | T50 (° C.) | |
|---|---|---|
| | HC | CO |
| Pt (0.125)/CeBaO:Pt (0.375)/Al₂O₃ = 1:1 (mass ratio) | 287 | 278 |
| Pt (0.125)/CeBaO:Pt (0.875)/Al₂O₃ = 1:1 (mass ratio) | 265 | 259 |
| Pt (0.125)/CeBaO:Pt (0.375) + Pd (0.3)/Al₂O₃ = 1:1 | 252 | 243 |
| (mass ratio) | | |

CeBaO is a Ce—Ba composite oxide containing 8 mol % of BaO.

Table 10 shows that also when the Ce—Ba composite oxide are used as composite oxide, high exhaust gas purification performance was obtained and the particulate burning rate increased. Furthermore, as in Embodiment 2, the exhaust gas purification performance and the carbon burning rate gradually enhanced as the alumina-side Pt loading ratio increased, but the carbon burning rate decreased when the alumina-side Pt loading ratio was excessive. This case is also characterized in that higher carbon burning rates were exhibited. Also in this case, when the alumina-side Pt loading ratio increased from 0 mass % to 25 mass %, both the exhaust gas purification performance and the carbon burning rate significantly enhanced. Therefore, the alumina-side Pt loading ratio is preferably not less than 25 mass %.

Table 11 shows that also in the case of using the Ce—Ba composite oxide, as in the case of using the Ce—Sm composite oxide in Embodiment 1, the Pd additionally loading DPF sample exhibited better T50 performance for HC and CO than the Pt additionally loading DPF sample.

### OTHER EMBODIMENTS

In the above embodiments, the content of rare earth metal or alkali earth metal in each composite oxide whose major component is Ce is 4 mol % or 8 mol %. In this respect, as is evident from data on carbon burning rate in FIG. 6, it can be expected that the carbon burning rate will be increased by increasing the content of rare earth metal or alkali earth metal. Therefore, the content of rare earth metal or alkali earth metal may be increased within the range less than 50 mol %, for example, to 10 mol % or 20 mol %.

What is claimed is:

1. A diesel particulate filter, disposed in an exhaust passage of a diesel engine, for trapping particulates exhausted from the engine, wherein
walls forming exhaust gas channels in a filter body on which the particulates are trapped are coated with a catalyst layer for promoting the burning of the trapped particulates,
the catalyst layer contains alumina and a composite oxide containing Ce as a major component and rare earth metal other than Ce or alkali earth metal, and
Pt is loaded on the alumina and the composite oxide.

2. The diesel particulate filter of claim 1, wherein the ratio of the amount of Pt loaded on the alumina to the total amount of Pt loaded on the composite oxide and Pt loaded on the alumina is not less than 35 mass %.

3. The diesel particulate filter of claim 2, wherein the ratio is not more than 90 mass %.

4. The diesel particulate filter of claim 1, wherein Pd is further loaded on the alumina on which Pt is loaded.

5. The diesel particulate filter of claim 1, wherein the rare earth metal comprises at least one selected from Sm and Gd.

6. The diesel particulate filter of claim 4, wherein the rare earth metal comprises at least one selected from Sm and Gd.

7. The diesel particulate filter of claim 1, wherein the alkali earth metal comprises at least one selected from Mg, Ca, Sr and Ba.

8. The diesel particulate filter of claim 4, wherein the alkali earth metal comprises at least one selected from Mg, Ca, Sr and Ba.

9. The diesel particulate filter of claim 5, wherein the alkali earth metal comprises at least one selected from Mg, Ca, Sr and Ba.

10. The diesel particulate filter of claim 6, wherein the alkali earth metal comprises at least one selected from Mg, Ca, Sr and Ba.
